(19) United States
(12) Patent Application Publication
(10) Pub. No.: US 2010/0092726 A1
(43) Pub. Date: Apr. 15, 2010

(54) COMPOSITE MATERIAL, PARTICULARLY SYNTHETIC LEATHER

(75) Inventors: Markus Schuette, Osnabrueck (DE); Hauke Malz, Diepholz (DE); Cord Schmalkuche, Bad Essen (DE); Juergen Weiser, Schriesheim (DE); Nidia Bustos, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/520,254

(22) PCT Filed: Dec. 12, 2007
(86) PCT No.: PCT/EP2007/063786

§ 371 Date: Aug. 21, 2009

(30) Foreign Application Priority Data
Dec. 22, 2006 (EP) 06126968.4

(51) Int. Cl. B32B 3/00; B32B 27/40; D04H 13/00; B32B 5/18; B32B 5/00; B32B 7/12; B32B 5/02; B32B 37/00

(52) U.S. Cl. 428/141; 428/423.1; 442/394; 428/319.3; 428/423.3; 428/318.6; 428/334; 428/335; 428/336; 428/317.7; 442/334; 156/60

(57) ABSTRACT

A composite material, wherein the composite material comprises, in firmly bonded form,
(i) a top layer based on a plastic dispersion and
(ii) a substrate layer selected from a film based on thermoplastic polyurethane, a nonwoven based on thermoplastic polyurethane and/or polyurethane foam.

The invention relates to composite material, in particular imitation leather, the composite material comprising, in adhesively bonded form,
(i) a top layer, in particular a finish, based on a plastic dispersion, preferably a polyurethane dispersion, and
(ii) a substrate layer selected from a film based on thermoplastic polyurethane, a nonwoven based on thermoplastic polyurethane and/or polyurethane foam, preferably a nonwoven based on thermoplastic polyurethane.

Furthermore, the invention relates to processes for the production of composite material, in particular imitation leather, a top layer (i), preferably a finish, being prepared using an aqueous plastic dispersion, preferably a polyurethane dispersion, preferably a polyurethane dispersion comprising an isocyanate crosslinking agent, which is applied to a structured surface of an underlay based on silicone rubber, preferably by spraying, knifecoating, roll-coating and/or a pouring, the underlay having a temperature of from 80 to 90° C., and a film based on thermoplastic polyurethane, a nonwoven based on thermoplastic polyurethane and/or polyurethane foam, preferably a nonwoven based on thermoplastic polyurethane, as substrate layer (ii) then being bonded to that surface of the top layer (i) which is facing away from the structured surface of the underlay.

Leather, being a high-quality material, has applications in many areas of daily life, e.g. shoes, seat coverings in the automotive and furniture sector and apparel. In particular, the pleasant haptic properties and the proverbial toughness of the leather, i.e. the mechanical strength, are sought-after properties of the material leather. However, leather has the disadvantage that it is not very breathable, i.e. moisture, e.g. in the form of perspiration, is not readily transported through a leather layer to the outside. In many applications typical of leather, this limits the comfort, e.g. in the case of car seats or in the case of shoes. Attempts have been made to avoid or at least to reduce this disadvantage of poor breathability, for example, by perforation of the leather. However, this reduces the water-tightness of the product, which is a major disadvantage in the case of rain, for example in the case of shoes and items of apparel, but also in the case of leather-covered seats, since the water can pass through the leather and thus wet the foam upholstery.

WO 2005/047549 describes the production of a substrate which is based, for example, on leather and is provided on its visible side with a finish based on a plastic dispersion, which finish has a grain structure. The substrate materials described there (split leathers or microfiber nonwovens) have the disadvantage that they have insufficient resilience for many applications. As a result, the advantage of the resilient top layer is canceled out. Furthermore, leather is a natural product of varying quality which is available in large pieces only to a limited extent (depending on the animal) and cannot be obtained as material wound on rolls. Moreover, it can be produced only by comparatively expensive processing. In the case of microfiber nonwovens, polypropylene, polyester or polyamide fibers are usually used. Sufficient adhesion of the top layer to the substrate can be achieved in such cases only by an additional application of adhesive. The intermediate adhesive layer is an additional barrier layer for water vapor and therefore frequently leads to a significant deterioration in the water vapor permeability of the composite material. Another disadvantage of these known solutions is the material mix, which makes it more difficult to recycle the products.

The object of the present invention was therefore to provide a substrate for a finish, for example a finish described in WO 2005/047549 and having the appearance of leather, which substrate can be produced
easily,
economically and
in a large area, preferably continuously, for example as material wound on a roll, which
forms a bond directly with the finish or can be produced directly on the finish,
whose mechanical properties can be varied over a wide Shore hardness range, which
has good breathability,
has good further processability and, if appropriate,
is water-tight.
In particular it is intended to provide a composite material, preferably imitation leather, which has particularly high resilience in comparison with known imitation leather.
The product to be provided should have good processing and recycling properties.

This object could be achieved by the composite materials presented at the outset, in particular the substrate layers according to the invention.

The composite materials according to the invention, in particular the imitation leathers, are distinguished in that, owing to the substrate according to the invention, it is possible to obtain materials which can be elastically and reversibly stretched and have no permanent deformation after stretching. Thus, it was possible substantially to increase the resilience, for example expressed as reversible stretchability. Moreover, the products according to the invention have the advantage of comprising one type of substance with regard to the material and can be more readily recycled as all-PU solution.

In addition, polyurethanes generally have excellent adhesion to other materials. Under certain conditions, the use of polyurethanes according to the invention therefore makes it possible to dispense with adhesives, with the result that expensive and time-consuming processing steps can be omitted. The foam layer can, for example, be applied in situ by a spray process. Application of the TPU nonwoven can be achieved by direct application of the still hot, presolidified fiber composite. Adhesive reapplication of a TPU film is conceivable by direct extrusion onto the top layer.

The substrate is preferably a nonwoven since, owing to its porous structure, this offers better breathability than a film. It is also preferable to use an open-cell, microcellular polyurethane foam which, in addition to good breathability, also has advantages owing to the possibility of being able to be processed in a continuous, solvent-free spray application.

Below, the various components of the composite materials according to the invention and the processes for their production are described.

Top Layer (i) Based on Plastic Dispersion

Plastic dispersions known for this purpose, preferably polyurethane dispersions, for example those which are described in WO 2005/047549 on page 6, line 8 to page 7 line 38, can generally be used as the top layer, but can also be designated as finish. The top layer is preferably the visible surface, i.e. the finish of the imitation leather. Preferably, the visible surface of the layer has a grain structure, i.e. the appearance of leather. In the preparation of the top layer, an aqueous dispersion is thus generally applied to the structured surface of the underlay comprising silicone rubber by spraying, knifecoating, roll-coating or pouring. The underlay is preferably heated by a heating device so that the surface of the underlay has a temperature of about 80° C. everywhere. A polyurethane dispersion in the form of spray mist is applied to this heated surface, usually via spray nozzles. Thereafter, solidification of the spray mist is effected by removal of water so that a thin film having capillaries is formed on the underlay. As soon as the film is dry to the touch, the substrate material is generally applied. The top layer preferably consists of a combination of a solidified polyurethane dispersion comprising a crosslinking agent having a high softening point and a solidified polyurethane dispersion (polyester-polyurethane) likewise comprising a crosslinking agent and having a low softening point. Both dispersions are thermoplastic prior to crosslinking. In order to change the surface tension of the top layer relative to water, and thus to improve the physical fastnesses of the layer, silicone handle agents can be used. In addition, pigments and isocyanate crosslinking agents can be used. The top layer (i) is therefore preferably the reaction product of an aqueous polyurethane dispersion comprising a crosslinking agent, preferably isocyanate crosslinking agent. In the composite material, the top layer (i) preferably has a thickness of from 20 μm to 100 μm, particularly preferably from 40 to 50 μm. In the composite material according to the invention, the top layer (i) is firmly bonded to the layer (ii), preferably adhesively bonded by means of a polyurethane dispersion.

Substrate Layer (ii) Based on a Film of Thermoplastic Polyurethane

Generally known and commercially available films can be used as films based on thermoplastic polyurethane, also referred to in this document as TPU. A water vapor-permeable TPU is preferably used. It is preferable to use a film based on thermoplastic polyurethane based on polyetherdiols prepared by alkoxylation of difunctional initiators, the alkylene oxide used being ethylene oxide and the proportion by weight of ethylene oxide, based on the total weight of the alkylene oxides used, being at least 50% by weight. The thickness of the film is preferably from 10 μm to 2 mm, particularly preferably from 10 μm to 1 mm, in particular from 10 μm to 0.3 mm. A thermoplastic polyurethane film having a thickness of less than 100 μm, preferably less than 50 μm, particularly preferably less than 20 μm, can preferably be used, the water vapor permeability according to DIN 53122-1 preferably being greater than 1.5 mg/cm². Furthermore, compact polyurethane films based on a reactive system, for example those described in U.S. Pat. No. 5,521,273, are preferred.

Substrate Layer (ii) Based on a Nonwoven, Preferably Nonwoven Based on Thermoplastic Polyurethane

Nonwoven is understood as meaning a layer, a nonwoven and/or a fiber gauze comprising oriented or random fibers, consolidated by friction and/or cohesion and/or adhesion.

Preferably, paper or products which have been woven, knitted, tufted, stitch-bonded with the use of winding yarns or filaments or felted by wet milling are not treated as nonwovens in the context of this application.

In a preferred embodiment, a material is to be regarded as “nonwoven” in the context of this application when more than 50%, in particular from 60 to 90%, of the mass of its fibrous constituent consists of fibers having a ratio of length to diameter of more than 300, in particular of more than 500.

In a preferred embodiment, the individual fibers of the nonwoven have a diameter of from 100 μm to 0.1 μm, preferably from 50 μm to 0.5 μm, in particular from 10 μm to 0.5 μm.

In a preferred embodiment, the nonwovens have a thickness of from 0.01 to 5 millimeters (mm), more preferably from 0.1 to 2 mm, particularly preferably from 0.15 to 1.5 mm, measured according to ISO 9073-2.

In a preferred embodiment, the nonwovens have a mass per unit area of from 20 to 1000 g/m², particularly preferably from 50 to 500 g/m², especially preferably from 100 to 350 g/m², measured according to ISO 9073-1.

The nonwoven may additionally be mechanically consolidated. Mechanical consolidation may be a one-sided or two-sided mechanical consolidation, a two-sided mechanical consolidation being preferred.

The nonwoven may additionally be chemically consolidated. In the chemical consolidation, the nonwoven is consolidated by addition of a chemical assistant, e.g. of an adhesive.

In addition to the mechanical and chemical consolidation described above, the nonwoven may additionally be thermally consolidated. The thermal consolidation can be effected, for example, by treatment of the nonwoven with hot air.

If the nonwoven is consolidated, it is preferably thermally consolidated.

Below, 4 parameters (P1 to P4) which the nonwoven (ii) used may have in the preferred embodiments are described.
P1) In one embodiment, the nonwoven used has a tensile strength in the production direction of from 5 Newton (N) per 5 cm to 1000 N per 5 cm, preferably from 40 N per 5 cm to 1000 N per 5 cm, in particular from 100 N to 1000 N per 5 cm (measured according to DIN EN 12127).
P2) In one embodiment, the nonwoven used has a tensile strength perpendicular to the production direction of from 5 Newton (N) per 5 cm to 1000 N per 5 cm, preferably from 40 N per 5 cm to 1000 N per 5 cm, in particular from 100 to 1000 N per 5 cm (measured according to DIN EN 12127).
P3) In one embodiment, the nonwoven used has an elongation in the production direction of from 10% to 800%, preferably from 50% to 800%, in particular from 250% to 800%, measured according to DIN EN 29073 Part 3.
P4) In one embodiment, the nonwoven used has an elongation in the direction opposite to the production direction of from 10% to 800%, preferably from 50% to 800%, in particular from 250% to 800%, measured according to DIN EN 29073 Part 3.

In a preferred embodiment, the nonwoven has at least two, more preferably at least 3 and in particular all of the features P1 to P4.

The nonwoven used comprises thermoplastic polyurethane. This is to be understood to mean that the nonwoven used comprises thermoplastic polyurethane, preferably comprises it as an essential constituent. In a preferred embodiment, the nonwoven used comprises thermoplastic polyurethane in an amount of from 60% by weight to 100% by weight, particularly preferably of more than 80% by weight, in particular more than 95% by weight, based on the total weight of the nonwoven.

In addition to thermoplastic polyurethane, the nonwoven used may also comprise other polymers or assistants, such as, for example, polypropylenes or copolymers of polypropylenes, polyethylenes or copolymers of polyethylenes and/or polystyrene and/or copolymers of polystyrene, such as styrene/acrylonitrile copolymers.

Thermoplastic polyurethanes are polyurethanes which remain thermoplastic when they are repeatedly heated and cooled in the temperature range typical for processing and use of the material. Here, thermoplastic is understood as meaning the properties of the polyurethane whereby it repeatedly softens on heating and hardens on cooling in a temperature range of from 150° C. to 300° C. typical for polyurethane and, in the softened state, can be repeatedly shaped by flow as a shaped article, extrudate or worked part to give a semifinished product or articles.

The thermoplastic polyurethane used for the nonwoven is obtainable by reacting (a) isocyanates with (b) compounds reactive toward isocyanates, preferably having a number-average molecular weight of from 500 to 10 000 g/mol, and, if appropriate, (c) chain extenders having a molecular weight of from 50 to 499 g/mol, if appropriate in the presence of (d) catalysts and/or (e) assistants. The corresponding starting materials and also the products, i.e. the TPU and nonwovens based on TPU, are generally known and commercially available.

In a preferred embodiment, the thermoplastic polyurethane which is used for the production of the nonwoven has a Shore hardness of from 50 Shore A to 74 Shore D, particularly preferably from 80 Shore A to 54 Shore D, measured according to DIN 53505.

The thermoplastic polyurethane as such usually has a density of from 800 to 1300 grams per liter (g/l), preferably from 1000 to 1250 g/l.

The preparation of the TPU can be effected by the known processes, continuously, for example using reaction extruders or the belt according to the one-shot or the prepolymer process, or batchwise according to the known prepolymer process. In these processes, the components (a), (b), and, if appropriate, (c), (d) and/or (e) reacted can be mixed with one another in succession or simultaneously, the reaction starting immediately.

In the extruder process, the components (a), (b) and, if appropriate, (c), (d) and/or (e) are introduced individually or as a mixture into the extruder and are reacted, for example, at temperatures of from 100 to 280° C., preferably from 140 to 250° C., and the TPU obtained is extruded, cooled and granulated.

In many applications the lightfastness of the nonwovens is important. Even if the nonwoven serves only as substrate, it may be that the finish is not thick enough to filter out all UV light. Aliphatic nonwovens, i.e. those which are based on aliphatic isocyanates, are therefore preferred in such cases.

The nonwovens comprising thermoplastic polyurethane can usually be produced from thermoplastic polyurethane described above by the meltblown process or spunbond process known from the prior art. Meltblown process and spunbond process are known in the technical area. The resulting nonwovens differ in general in their mechanical properties and their consistency. Thus, nonwovens produced by the spunbond process are particularly stable both in the horizontal and in the vertical direction but have an open-pore structure. Nonwovens produced by the meltblown process have a particularly dense network of fibers and therefore form a very good barrier to liquids.

Nonwovens can also be produced by combination of the meltblown process and spunbond process. These nonwovens have a particularly dense network of fibers and a very good barrier to liquids and possess very good mechanical properties. Nonwovens are preferably produced by a combination of the meltblown and spunbond process.

Substrate Layer (ii) Based on a Polyurethane Foam

The substrate layer (ii) can furthermore be based on generally known polyurethane foams, for example flexible or semirigid foams, e.g. those which are described in WO 2006/034 800, EP 1 595 901, DE 10 2004 048 571, EP 0 897 402, WO 2006/089 890 or WO 2006/097 508.

According to DIN 7726, a foam is defined as a material having cells distributed over the entire material and a gross density which is lower than the density of the framework substance. The foam is preferably for the most part open-cell. An open cell is defined as a cell which is connected to other cells via the gas phase. The density of the foam is preferably from 50 g/l to 800 g/l, particularly preferably from 150 g/l to 600 g/l, in particular from 150 to 500 g/l, especially preferably from 200 g/l to 400 g/l. The foam preferably has an elongation at break of greater than 100%.

The preparation of corresponding foams is also described in “Kunststoffhandbuch, Volume 7, Polyurethane”, Carl Hanser Verlag, 3rd Edition 1993, Chapters 5 and 7.

If a polyurethane foam is used as substrate layer (ii), a flexible polyurethane foam is preferred as substrate layer (ii).

If a polyurethane foam is used as substrate material, the thickness of the substrate layer is preferably from 10 μm to 5 mm, particularly preferably from 30 μm to 1 mm, in particular from 50 μm to 600 μm. A particularly preferred flexible polyurethane foam is described in EP-A 1 595 901.

In contrast, a large number of other processes for the production of microporous PU coatings are also known. An overview in this context is to be found in E. Träubel. An example of a patent relating to the prior art is DE 24 35 880.

The production of the substrate material can be effected by knifecoating techniques or by spraying in a continuous (preferred) or batchwise manner.

The present invention furthermore relates to processes for the production of composite materials, in particular imitation leather, a top layer (i) being prepared using an aqueous plastic dispersion, preferably polyurethane dispersion, preferably polyurethane dispersion comprising isocyanate crosslinking agent, which is preferably applied to a structured surface of an underlay based on silicone rubber by spraying, knifecoating, roll-coating and/or pouring, the underlay having a temperature of from 80 to 90° C., and a film based on thermoplastic polyurethane, a nonwoven based on thermoplastic polyurethane and/or a polyurethane foam as substrate layer (ii) then being bonded to that surface of the top layer (i) which is facing away from the structured surface of the underlay. The substrate layer (ii) can be firmly bonded to the top layer (i) by spray application. A process of this type is described, for example, in WO 2006/097508.

We claim:

1. A composite material, wherein the composite material comprises, in firmly bonded form,
(i) a top layer based on a plastic dispersion and
(ii) a substrate layer selected from a film based on thermoplastic polyurethane, a nonwoven based on thermoplastic polyurethane and/or polyurethane foam.

2. The composite material according to claim 1, wherein the visible surface of the top layer has a grain structure.

3. The composite material according to claim 1, wherein the top layer (i) is the reaction product of an aqueous polyurethane dispersion comprising a crosslinking agent.

4. The composite material according to claim 1, wherein the top layer (i) has a thickness of from 20 μm to 100 μm.

5. The composite material according to claim 1, wherein the top layer (i) is adhesively bonded to the layer (ii) by means of a polyurethane dispersion.

6. The composite material according to claim 1, wherein the film based on thermoplastic polyurethane is water-vapor-permeable.

7. The composite material according to claim 1, wherein the film based on thermoplastic polyurethane is based on polyetherdiols prepared by alkoxylation of difunctional initiators, the alkylene oxide used being ethylene oxide and the proportion by weight of ethylene oxide, based on the total weight of the alkylene oxides used, being at least 50% by weight.

8. The composite material according to claim 1, wherein the nonwoven is based on thermoplastic polyurethane prepared using aliphatic isocyanates.

9. The composite material according to claim 1, wherein the nonwoven consists of fibers whose ratio of length to diameter is greater than 300.

10. The composite material according to claim 1, wherein the fibers of the nonwoven have a diameter of from 100 μm to 0.1 μm.

11. The composite material according to claim 1, wherein the nonwoven (ii) has a thickness of from 0.01 mm to 5 mm, measured according to ISO 9073-2.

12. The composite material according to claim 1, wherein the nonwoven (ii) has a mass per unit area of from 20 g/m² to 1000 g/m², measured according to ISO 9073-1.

13. The composite material according to claim 1, wherein the polyurethane foam is a flexible foam.

14. The composite material according to claim 1, wherein the polyurethane foam has a thickness of from 50 μm to 600 μm.

15. The composite material according to claim 1, wherein the polyurethane foam has a density of from 150 to 500 g/l.

16. A process for the production of composite material, wherein a top layer (i) is prepared using an aqueous plastic dispersion, which is applied to a structured surface of an underlay based on silicone rubber, preferably by spraying, knifecoating, roll-coating and/or pouring, the underlay having a temperature of from 80 to 90° C., and a film based on thermoplastic polyurethane, a nonwoven based on thermoplastic polyurethane and/or a polyurethane foam as substrate layer (ii) is then bonded to that surface of the top layer (i) which is facing away from the structured surface of the underlay.
